(19) United States
(12) Patent Application Publication
(10) Pub. No.: US 2017/0061423 A1
(43) Pub. Date: Mar. 2, 2017

(54) USE OF WEARABLE AS AN ACCOUNT CONTROL SYSTEM

(71) Applicant: BANK OF AMERICA CORPORATION, Charlotte, NC (US)

(72) Inventors: Matthew K. Bryant, Gastonia, NC (US); Nathan Dent, Concord, NC (US); Nicholas Munson, Charlotte, NC (US)

(21) Appl. No.: 14/842,310

(22) Filed: Sep. 1, 2015

(51) Int. Cl. G06Q 20/32

(52) U.S. Cl. CPC G06Q 20/3226; G06Q 20/3224

(57) ABSTRACT

The present disclosure describes using wearable to control user account operation. Embodiments herein disclosed receive an operation request from a wearable device of a user to control the operation of at least one account of the user using the wearable device; wherein the operation includes turning on or off the account, placing a limit on a payment for a transaction, and/or the like; wherein the wearable device has one or more sensors configured to gather user data including physiological or movement data, or a combination of both. Embodiments herein disclosed determine whether or not the user is in possession of the wearable device, based on the user data; and grant the operation request to control the operation of the at least one account, based at least partially on the determination of that the user is in possession of the wearable device.

### FIELD OF THE INVENTION

This disclosure generally relates to using the presence of a wearable device to control user account operation.

### BACKGROUND

Customers of financial institutions desire convenient, quick, and secure control over their accounts. One barrier to such control over accounts is the verification process normally required to determine that the customer is the actual owner of the account. The customer normally has to provide identification information, signatures, passcodes, a zip code, or other potentially sensitive information to perform an action with an owned account.

### SUMMARY OF THE INVENTION

The following presents a summary of certain embodiments of the present invention. This summary is not intended to be a comprehensive overview of all contemplated embodiments, and is not intended to identify key or critical elements of all embodiments nor delineate the scope of any or all embodiments. Its sole purpose is to present certain concepts and elements of one or more embodiments in a summary form as a prelude to the more detailed description that follows.

Methods, systems, and computer program products are described herein that provide for controlling user account operation.

Some embodiments characterize a system that includes a computer apparatus including at least one processor and a memory; and a software module, stored in the memory, including computer readable code executable by the processor. The software module is configured to receive, via a communication interface, an operation request from a wearable device of a user to control the operation of at least one account of the user using the wearable device; wherein the wearable device comprises one or more sensors configured to gather user data comprising physiological or movement data, or a combination of both; wherein the operation comprises turning on or off the account, placing a limit on a payment for a transaction, and the like. The software module is further configured to determine whether or not the user is in possession of the wearable device, based on the user data; grant the operation request to control the at least one account, based at least partially on determination that the user is in possession of the wearable device; and provide, via the communication interface, a notification to the user indicating that the operation request has been granted.

Some embodiments feature a computer implemented method that includes the step of: receiving, via a communication interface, an operation request from a wearable device of a user to control the operation of at least one account of the user using the wearable device; wherein the wearable device comprises one or more sensors configured to gather user data comprising physiological or movement data, or a combination of both; wherein the operation comprises turning on or off the account, placing a limit on a payment for a transaction, and the like. The method further includes the steps of: determining whether or not the user is in possession of the wearable device, based on the user data; granting the operation request to control the at least one account, based at least partially on determination that the user is in possession of the wearable device; and providing, via the communication interface, a notification to the user indicating that the operation request has been granted.

Further embodiments provide a computer program product that includes a non-transitory computer readable medium including computer readable instructions. The computer readable instructions include instructions for receiving, via a communication interface, an operation request from a wearable device of a user to control the operation of at least one account of the user using the wearable device; wherein the wearable device comprises one or more sensors configured to gather user data comprising physiological or movement data, or a combination of both; wherein the operation comprises turning on or off the account, placing a limit on a payment for a transaction, and the like. The computer readable instructions further include instructions for determining whether or not the user is in possession of the wearable device, based on the user data; granting the operation request to control the at least one account, based at least partially on determination that the user is in possession of the wearable device; and providing, via the communication interface, a notification to the user indicating that the operation request has been granted.

Implementations may include one or more of the following features.

In some implementations, the wearable device is paired with a mobile device of the user via a secure channel between the two devices over a short range wireless communication channel, wherein the secure channel is established by utilizing one or more applications provided by the system or by third-parties, and wherein the mobile device comprises a positioning device.

In some implementations, the user data is transmitted to the mobile device or to an online storage site, both accessible to the system.

In some implementations, the operation request is sent from the mobile device.

In some implementations, the software module is further configured to: determine, via the positioning device, the location of the mobile device of the user; determine, via the secure channel, that the mobile device is paired with the wearable device; and determine that the user is in possession of the wearable device, in response to determination of the location of the mobile device and that the mobile device is paired with the wearable device.

In some implementations, the operation request comprises the user account information comprising a username, a password, a personal identification number (PIN), an account number, a card number, one or more related accounts, or any combination thereof.

In some implementations, the operation comprises preauthorizing one or more transactions, approving one or more transactions that are forwarded to the wearable device for approval, periodically transferring a pre-specified amount from one account to another account, or the like.

In some implementations, the physiological data comprises heart rate, blood pressure, fingerprints, finger vein and palm vein patterns, temperature, and the like; wherein the movement data comprises body movements, gait, and the like.

In some implementations, the wearable device comprises a watch, a wristband, an ear-pod, a necklace, a wristlet, an anklet, an earring, a headband, a ring, a belt, eyeglasses, contact lenses, clothing, or the like.

In some implementations, the at least one account comprises a deposit account, a debt account, a savings account, a checking account, an investment account, a money market account, a credit account, or the like.

Other implementations, features and advantages are in the description, drawings and claims.

### BRIEF DESCRIPTION OF THE DRAWINGS

Having thus described embodiments of the invention in general terms, reference may now be made to the accompanying drawings:

FIG. 1 is a block diagram illustrating a system environment including a system for controlling user account operation, in accordance with an embodiment of the invention;

FIG. 2 is a flowchart illustrating a general process for controlling user account operation, in accordance with an embodiment of the present invention; and

FIG. 3 is a flowchart illustrating a general process for determining whether or not the user is in possession of the wearable device, in accordance with one embodiment of the present invention.

### DETAILED DESCRIPTION OF EMBODIMENTS OF THE INVENTION

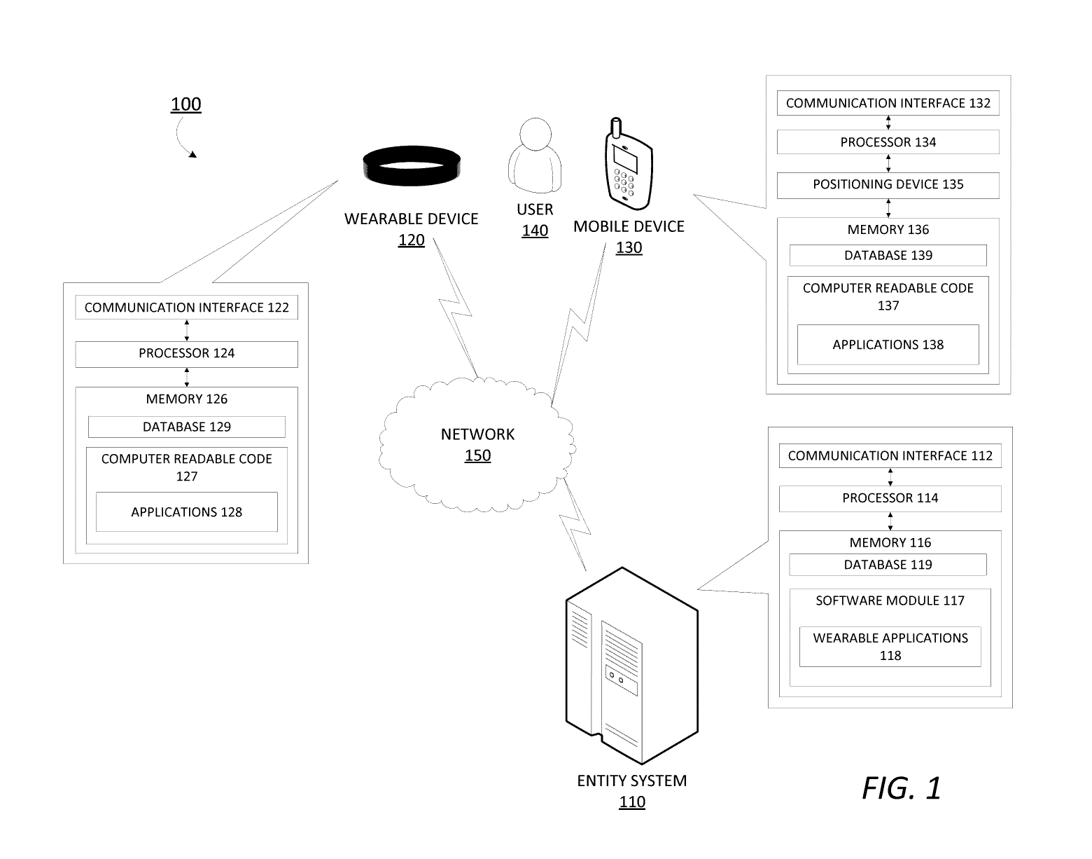

Embodiments of the present invention will now be described with respect to FIGS. 1-3. In the drawings, like reference characters and numbers refer to like elements throughout. Also, the drawings are not necessarily to scale, emphasis instead generally being placed upon illustrating the principles of the invention.

As may be appreciated by one of skill in the art, the present invention may be embodied as a method, system, computer program product, or a combination of the foregoing. Accordingly, the present invention may take the form of an entirely software embodiment (including firmware, resident software, micro-code, and the like) or an embodiment combining software and hardware aspects that may generally be referred to herein as a “system.” Furthermore, embodiments of the present invention may take the form of a computer program product on a computer-readable medium having computer-usable program code embodied in the medium.

In some embodiments, any suitable computer-readable medium may be utilized. In other embodiments, a specialized computer-readable medium may be utilized that is configured for specific functions that encompass more than generic computer functions. The computer-readable medium may be, for example but not limited to, an electronic, magnetic, optical, electromagnetic, infrared, or semiconductor system, apparatus, device, or propagation medium. More specific examples of the computer readable medium include, but are not limited to, the following: an electrical connection having one or more wires; a tangible storage medium such as a portable computer diskette, a hard disk, a RAM, a read-only memory (ROM), an erasable programmable read-only memory (EPROM or Flash memory), a compact disc read-only memory (CD-ROM), or other optical or magnetic storage device; or transmission media such as those supporting the Internet, an intranet, or a wireless network. Note that the computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Computer program code for carrying out operations of embodiments of the present invention may be written in an object oriented, scripted or unscripted programming language such as Java, Perl, Smalltalk, C++, or the like. However, the computer program code for carrying out operations of embodiments of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Embodiments of the present invention are described below with reference to flowchart illustrations and/or block diagrams of methods, apparatus (systems), and computer program products. It may be understood that each block of the flowchart illustrations and/or block diagrams, and/or combinations of blocks in the flowchart illustrations and/or block diagrams, can be implemented by computer program instructions. These computer program instructions may be provided to one or more processors of a general purpose computer, special purpose computer, or other programmable data processing apparatus to produce a machine, such that the instructions, which execute via the processor of the computer or other programmable data processing apparatus, create mechanisms for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer readable memory produce an article of manufacture including instruction means which implement the function/act specified in the flowchart and/or block diagram block(s).

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

Wearable devices, smart or otherwise, are becoming more prevalent in a variety of markets and industries. The devices may be used in many operations, such as but not limited to identifying a user, storage and transmission of user credentials, storage and transmission of financial information, general user-data storage, user biometric monitoring, and the like. In particular, wearable devices may be used to share user credentials and to perform financial transactions. Most wearable devices communicate data through wireless Wi-Fi, near field communication (NFC), radio frequency identification (RFID), long-term evolution (LTE), and other wireless technologies. Identification in consumer based industries may be led by the integration of wearable technology with authentication and identification in both physical and virtual environments. Examples of potential wearable devices that could be included in this integration are smart watches, bands, ear-pods, jewelry, eyeglasses, contact lenses, clothing, and the like. In some circumstances, a wearable device is an entire item (e.g., a smart watch). In other circumstances, a wearable device is a component, chip, section, or other element of a piece of clothing, jewelry, or the like. In such embodiments, the component wearable device may be attached to or embedded within some other article and may be removable, exchangeable, and the like.

A typical financial transaction executed by a user may require the user to present a payment vehicle (e.g., credit card, debit card, or the like) to the merchant to complete the transaction. During the process of executing the transaction, the merchant may require the user to provide additional authentication credentials to confirm the identity of the user. This may be in the form of a valid identification document, a signature, a PIN, or the like. Although this form of identification confirmation during the process of executing the transaction may provide a sense of trustworthiness to the merchant, it may result in unnecessary inconvenience to the user. With users performing a multitude of transactions using wearable devices in the financial industry, there is a need to ensure security and convenience. Although wearable devices may be used as a form of a payment vehicle at contactless point-of-sale terminals at merchant locations, the merchant may still have to confirm the identity of the user donning the wearable device at every interaction to determine the trustworthiness of the user and reduce the likelihood of misrepresentation.

Embodiments of the present invention are directed to systems, methods and computer program products for controlling user account operation using a wearable device. Some embodiments arise, in part, from the realization that a system can advantageously be configured to receive an operation request from a wearable device of a user to control the operation of at least one account using the wearable device (e.g., turning on or off the account or placing a limit on a payment for a transaction). Such embodiments determine whether or not the user is in possession of the wearable device, based on user data, such as biometric feedback associated with user received from the wearable device, wherein the biometric feedback is generated by physiologic tracking technology incorporated into the wearable device that can read and record the user's biometric traits such as heart rate, blood pressure, gait, or other types of physical activity. Such determinations may also be made by verifying that the user is wearing the wearable device and then monitoring the attached nature of the wearable device (e.g., monitoring a clasp, latch, pressure sensor, or the like). Such embodiments grant the operation request to control the operation of the user account via the wearable device, based at least partially on the determination of that the user is in possession of the wearable device, thereby enabling the user to use the wearable device as a remote control for financial account operation.

Referring now to FIG. 1, a block diagram of a system environment 100 is provided, which includes an entity system 110 owned by an entity for controlling user account operation, a wearable device 120 associated with a user 140, a mobile device 130 of the user 140, and a network 150. The entity system 110, the wearable device 120 and the mobile device 130 communicate with one another through the network 150, for example by sending electrical singles to each other over the network 150 to perform the actions discussed within this specification and illustrated in the figures. Other devices, systems, servers, or the like may also be included in the system environment 100, such as but not limited to third party systems, which may facilitate the transactions of the user 140 by providing hardware and/or applications, or may be merchant systems that receive the requests for the transactions directly from the user 140 or from the entity system 110.

A “system environment,” as used herein, may refer to any information technology platform of an enterprise (e.g., a national or multi-national corporation) and may include a multitude of servers, machines, mainframes, personal computers, network devices, front and back end systems, database systems and/or the like.

An “entity,” as used herein, may refer to any business, group of businesses, or person working in the interest of the entity, that has authorization to act on behalf of customers in regard to customers' finance management and/or related operation. For example, an entity may be a financial institution, a mortgage company, a financial consulting firm, a commercial bank, an investment company, or the like. As used herein, the terms “customer” and “user” are interchangeable, both referring to a person who is affiliated with an entity herein defined. In some embodiments, an entity system 110 may refer to any organization which maintains the accounts of users 140.

As shown in FIG. 1, the entity system 110 includes a communication interface 112, at least one processor 114, and a memory 116. The memory 116 contains a software module 117, such as computer readable instructions having one or more wearable applications 118 built therein, and a database 119. The communication interface 112 may encompass a device that includes hardware, and, in some instances, software, that enables the authentication processing system 110, to transport, send, receive, and/or otherwise communicate information to and/or from the communication interfaces (122, 132, or the like) of one or more other systems on the network 150. For example, the communication interface may include a wireless transceiver, modem, server, electrical connection, and/or other electronic device that operatively connects the authentication processing system 110 to another system, over the network 150. The communication interface may further include an interface that accepts one or more network interface cards, ports for connection of network devices, Universal Serial Bus (USB) connectors and the like. In some embodiments, the entity system 110 may also include a proximity system (not shown), which may include a global positioning system (GPS), NFC, RFID, Bluetooth, or the like.

The processor 114 is operatively coupled to the memory 116 and configured to execute the computer readable code 117. The processor 114 may include a digital signal processor device, a microprocessor device, analog-to-digital converters, digital-to-analog converters, and other support circuits. Control and signal processing functions of the processor 114 may be allocated between these devices according to their respective capabilities. The processor 114 may also include functionality to operate other software programs based on computer executable code thereof, which may be stored, along with the wearable applications 118, on the entity system 110.

The memory 116 may include volatile memory, such as RAM having a cache area for the temporary storage of information. The memory 116 may also include non-volatile memory that may be embedded and/or removable. The non-volatile memory may additionally or alternatively include an Electrically Erasable Programmable Read-Only Memory (EEPROM), flash memory, and/or the like. The memory may store any one or more of pieces of information and data used by the system in which it resides to implement the functions of that system. The memory 116 may include the wearable applications 118 that are utilized to monitor, track, and send and receive, information related to the wearable device 120 as described throughout. The wearable application 118 may communicate with, or have portions of located in the other devices, systems, servers, or the like within the system environment.

The database 119 may archive device information (e.g., captured through the wearable applications 118, or the like) associated with wearable and/or mobile devices previously registered with the entity system 110 and user data including biometric information of customers affiliated with the entity. The database 119 may also store data related to and/or used by the wearable applications 118. The wearable applications 118 may perform one or more of the steps and/or sub-steps discussed herein and/or one or more steps not discussed herein.

It will be understood that the entity system 110 may be configured to implement one or more of the various user interfaces and/or process flow described herein. It will also be understood that, in some embodiments, the memory 116 includes other applications. It will also be understood that, in some embodiments, the entity system 110 may be configured to communicate with other entity systems or third-party systems (e.g., for purpose of capturing, identifying, or storing financial information, identification information, or the like the user 140). The third-party systems may be systems that facilitate the authentication or may be the merchant systems at which the user 140 is requesting to enter into a transaction.

In the embodiment shown in FIG. 1, the wearable device 120 includes a communication interface 122, a processor 124 and a memory 126. The communication interface 122, the processor 124, and the memory 126 are similar to the devices discussed with respect to the authentication processing system 110. However, the memory 126 includes computer readable instructions 127 having one or more applications 128 built therein, and a database 129. In many cases, the wearable device 120 includes one or more sensors configured to gather the physiological and/or movement data of the user 140, such as heart rate, blood pressure, fingerprints, wrist analysis, finger vein, wrist vein, and palm vein patterns, physiological vital signs, temperature, body movements, gait, fluid, skin, breath, or other analysis, or other types of physical activates, contact with the user 140, and the like. The one or more applications 128 may further comprise at least a portion of the wearable applications 118 from the authentication processing system 110. In some cases, the wearable device 120 may include one or more sensors configured to gather information about the wearable device 120, such as whether the wearable device 120 is locked, assembled, or connected, whether the wearable device 120 is secured to the user 140, geographical location of the wearable device 120, the presence of wearable devices, and the like. The wearable device 120 may, by way of example, include a watch, a wristband, an ear-pod, a necklace, a wristlet, an earring, a headband, a ring, a belt, eyeglasses, contact lenses, clothing, or the like, or a component of the like.

As shown in FIG. 1, the mobile device 130 includes a communication interface 132, a processor 134, positioning device 135, and a memory 136. The communication interface 132, the processor 134, and the memory 136 are similar to the devices discussed with respect to the authentication processing system 110. The memory 136 includes computer readable instructions 137 having one or more applications 138 built therein (e.g., one or more online banking applications, at least a portion of the wearable applications 118, or other applications) and a database 139. The mobile device 130 may, by way of example, include a smartphone, a personal digital assistant, a personal computer, an electronic notebook, or the like. The one or more applications 138 may include one or more online banking applications and wearable applications for pairing the mobile device 130 with the wearable device 120.

In some embodiments, the positioning device 135 may be any type of location determining device. In one embodiment the positioning device 135 may include a GPS transceiver. In other embodiments, the positioning device 135 is at least partially made up of an antenna, a transmitter and a receiver. Alternatively, the positioning device 135 may include a NFC interface having one or more proximity sensors embedded therein, such as a RFID tag. Alternatively, the positioning device 135 may be a Bluetooth device. In other embodiments, the positioning device 135 may be devices for allowing Wi-Fi triangulation. The positioning device 135 is specifically described as being part of the mobile device 130, it should be understood that a positioning device may also be included in the wearable device 120.

In some embodiments, the wearable device 120 may be paired with the mobile device 130 via a secure channel between the two unassociated devices over a short range wireless communication channel or other like communication link, providing a secure communicable link between the two devices 120, 130. The secure channel can be established by utilizing the system application directives, such as by the wearable applications 118, other entity applications, or through third-party web-based applications. Such a secure channel enables the wearable device 120 and mobile device 130 to achieve an extra level of maintained authorization because their connection is protected.

The entity system 110 may include the account information that the user is utilizing to enter into a transaction. Alternatively, the third-party systems (not illustrated) may include applications that allow the user to enter into a transaction, or they may be the merchant systems that receive a request from the user to enter into a transaction, and in response communicate with the entity system 110. The entity system 110 and the third-party systems may have communication devices, processors, memory, databases, and applications, as was described with respect to the authentication processing system.

The entity system 110, the wearable device 120 and the mobile device 130 are each operatively connected to the network 150 and in communication with one another, as well as in communication with other devices, systems, servers, or the like, such as the third-party systems. The network 150 may include various networking interfaces, such as a LAN, a WAN, a global area network (GAN) (e.g., the Internet), other types of networks, or a hybrid thereof.

The user 140 may utilize the devices in the system environment to enter into, and authenticate, transactions. In some embodiments the user may utilize the mobile device 130 and/or the wearable device to enter into the transactions. The entity system 110 may receive an operation request from the wearable device 120 to control the operation of at least one account of the user 140 using the wearable device 120. In some embodiments, the operation request may be sent by the user 140 from the mobile device 130 that is securely paired with the wearable device 120, and in such embodiments, the entity system 110 may communicate directly with the mobile device 130 to retrieve the operation request transmitted therefrom.

The operation requested by the user 140 may include turning on or off an account, such as to turn off a user financial account in the situation of that the user misplaced his credit card. The operation requested by the user 140 may also include placing a limit on a payment for a transaction, such as to place a limit on a restaurant bill when paying it. The operation requested by the user 140 may further include using the wearable device 120 and/or the mobile device 130 to make frequent transactions, such as to click one tap on the device for a withdrawal of a predetermined amount. In some embodiments, the operation may additionally include preauthorizing one or more transactions, approving one or more transactions that are forwarded to the wearable device for approval, periodically transferring a pre-specified amount from one account to another account, or any combination thereof.

The account, indicated in the request, may be a deposit account, a debit account, a savings account, a checking account, an investment account, a money market account, or a credit account. The operation request may include the account information associated with the at least one account, such as a username, a password, a PIN, an account number, a card number, one or more related accounts, or any combination thereof. In some embodiments, the operation request may additionally include device information associated with the wearable device 120 and/or the mobile device 130, which may be any information sufficient to generate a device “fingerprint”, or a unique signature of the user's wearable device 120 and/or the mobile device 130.

The entity system 110, after receiving the operation request from the user 140, determines whether or not the user 140 is in possession of the wearable device 120, based on the user data including the physiological data sent from the wearable device 120. In some embodiments, the user data is transmitted from the wearable device 120, while in other embodiments, the user data may be transmitted from the mobile device 130. The entity system 110 determines whether or not the user 140 is in possession of the wearable device 120 by comparing the received user data with the stored data associated with the user 140 in the database 119 to verify the identity of the user 140. In some embodiments, the entity system 110 verifies the identity of the user 140 by associating the device information, included in the operation request, with the wearable device 120 previously registered with the entity system 110.

In some embodiments, the authentication processing system 110 determines the location of the mobile device 130 and/or the wearable device 120 using a positioning device in one or more of the devices. In some embodiments, the entity system 110 determines the location of the mobile device 130 using a proximity system, which is embedded in the entity system 110 and configured to use proximity sensors located at various locations throughout the world to detect the presence of the one or more proximity sensors associated with the positioning device 135 of the mobile device 130 (or in other embodiments the positioning device of the wearable device 120). In some embodiments, triangulation of cellular signals transmitted from the mobile device 130 (or in other embodiments the positioning device of the wearable device 120), via a GPS transceiver, Wi-Fi triangulation, Bluetooth, or other like device from the mobile device 130 may be used to identify the location of the mobile device 130.

In some embodiments, the location of the wearable device 120 may determine through the mobile device 130 based on the positioning device 135 in the mobile device and a determination that the mobile device 130 is linked with the wearable device 120 (e.g., may require the devices to be a within a particular distance from each other.). For example, the entity system 110 may determine if the user 140 is in possession of the wearable device 120 by: determining the location of the mobile device 130, via the positioning device 135 thereon; determining, via the secure channel, that the mobile device 130 is paired with the wearable device 120; and determining that the user 140 is in possession of the wearable device 120, in response to determination of the location of the mobile device 130 and that the mobile device 130 is paired with the wearable device 120.

In addition to, or alternative to, determining the user data, the system may determine wearable device information related to if the wearable device 120 is being utilized by the user, such as being connected (e.g., watch clasp together, band connected, or the like), moving, latched, locked data, orientation data, or the like. Collectively, the user data and the wearable device data may be considered possession data, and such possession data may be any information that at least tends to show that the user is in possession of the wearable device.

If it is determined that the user 140 is in possession of the wearable device 120 (e.g., based on the user data and/or the wearable device data), the entity system 110 grants the operation request to control the account, indicated in the operation request, thereby enabling the user 140 to operate the account via the wearable device 120. The entity system 110 then provides a notification to the user 140 of that the operation request has been granted. In some embodiments, the notification may be presented to the user 140 through a confirmation interface (not shown) provided by the entity system 110. The confirmation interface may be installed on either the wearable device 120 or the mobile device 130, as a client-side application embedded in the computer readable code 127 or the computer readable code 137.

In some embodiments, the confirmation interface may be a graphic user interface (GUI), which enables communication between the entity system 110 and user 140 through direct manipulation of graphical elements on the GUI. The graphic elements include, but are not limited to, checkboxes, buttons, radio buttons, dropdown lists, list boxes, text fields, menu bars, and the like. In some embodiments, the confirmation interface may be an electronic communication interface, which can accommodate one or more input and/or output devices, such as display screens and/or speakers, microphones, keys, dials, touchscreens, scanners, cameras, and/or the like. In certain embodiments, the confirmation interface may be a web-based interface which enables the entity system 110 and user 140 to communicate with a server through a web browser.

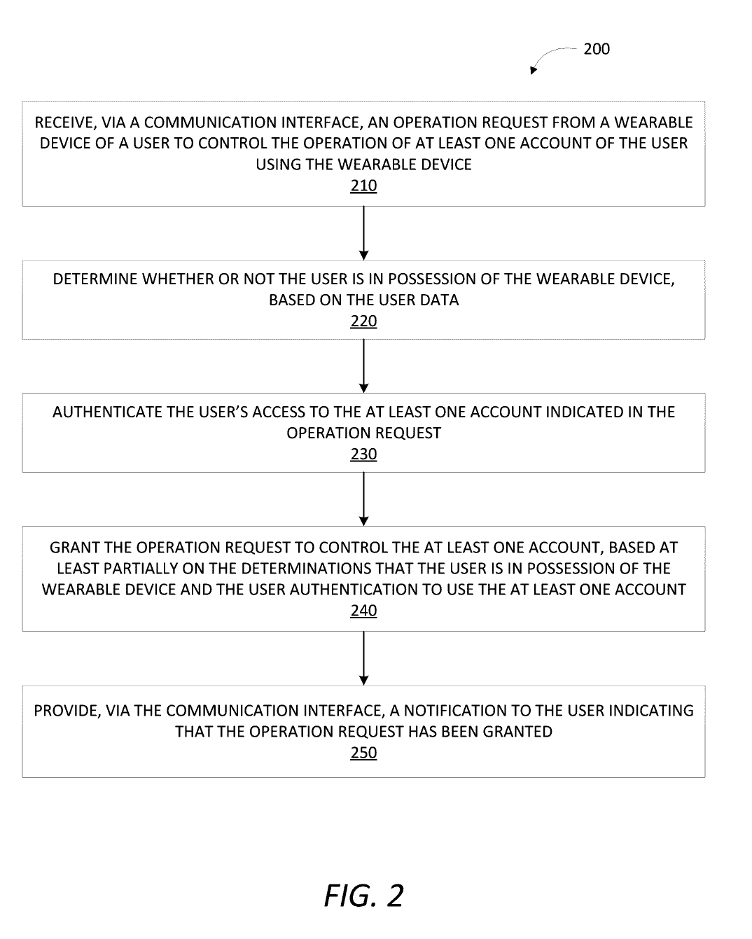

Turning now to FIG. 2, a general process flow 200 for controlling user account operation is provided. The process 200 can be executed by the entity system 110 in the system environment 100, as shown in FIG. 1.

The process 200 includes multiple components, which may all be performed via one or more processors on a system owned by an entity for controlling user account operation. The process 200 starts with block 210, where the system receives an operation request from a wearable device 120 of a user 140 to control the operation of at least one account of the user 140 using the wearable device 120. The operation request may be made by making the request through the confirmation interface on the wearable device 120 or utilizing another feature of the wearable device 120. The request may go directly to the entity system 110, or in other embodiments as described in further detail below the request may be transmitted to the mobile device 130 to relay the request to the entity system 110. As described above, the wearable device includes sensors configured to gather user data (e.g., physiological data, biometric data, user contact data, and the like) and wearable device data (e.g., location data, latched or locked data, orientation data, and the like).

Controlling user account operation may include turning on or off an account, such as to turn off a user financial account in case that the user 140 lost his credit card. Controlling user account operation may also include placing a limit on a payment for a transaction, such as to place a limit on a restaurant bill when paying it. Controlling user account operation may further include using the wearable device 120 to make frequent transactions. For example, the user 140 may make user jesters to make frequent transaction such as to click one tap on the device, move the wearable device in a pattern, or the like, for a withdrawal of a predetermined amount, or other transaction. Controlling user account operation may additionally include preauthorizing one or more transactions, approving one or more transactions that are forwarded to the wearable device for approval, periodically transferring a pre-specified amount from one account to another account, or any combination thereof. Controlling user account operation may also include preauthorizing or limiting transactions with specific merchants or types of merchants. The operation request may also include device information associated with the wearable device 120 and account information associated with the account that the user 140 wants to operate on.

Upon receipt of the operation request, the process 200 progresses to block 220 to determine whether or not the user 140 is in possession of the wearable device 120 based on data associated with the user 140 and/or the wearable device 120. As described above, this data is gathered by the wearable device 120 and/or a mobile device 130 associated with the user 140 and provides physiological, biometric, user contact, and other user data as well as location, orientation, and other wearable device data. The user data may be transmitted to a mobile device 130 of the user 140 or to an online storage site, both assessable to the system. In some embodiments, the system determines if the user 140 is in possession of the wearable device by comparing the received user data with stored data associated with the user 140 and by matching the device information associated with the wearable device 120 registered in the system.

For example, a smart watch wearable device or wearable band may alert the system that the wearable device is secured to a body part by sending information about the smart watch or band being latched, sensing heat of a person, sensing pressure of a person, sensing heart rate of a person, or other like user data or wearable device data that can be monitored and captured from the user 140 and/or wearable device 120. In some embodiments, the monitoring of the wearable device by the entity system 110 or other system may occur in intervals, or in real or near-time. This information may provide for the indication that the use is in possession itself, or may require further action by the user 140. For example, in one embodiment the user 140 need not take other action as the monitoring occurs. In other embodiments, the user 140 may be required to take additional actions once the determination is made that the wearable device is on or with the user 140. For example, the user associated with the smart watch or band may then be prompted to provide a response to confirm that the user is wearing the device, such as providing a fingerprint to a fingerprint sensor on the smart watch or a band. In this example, this fingerprint will be checked against a record of the user's fingerprint(s) to determine whether the fingerprint is actually the expected user's fingerprint. Once the fingerprint is verified, and the wearable device 120 maintains a status of being secured to the user 140, the system can fairly confidently determine that the user 140 is in possession of the wearable device 120.

In another example, the system can prompt the user 140 to input a personal identification code and assert that the user 140 is in possession of the wearable device 120. In another example, the system can determine that the wearable device 120 is in close proximity to a mobile device 130 of the user 140, and therefore likely in possession of the user 140. In some embodiments, the system uses several indicators to determine that the user 140 is in possession of the wearable device 120. For example, the system may use any combination of assertions by the user (before or after a verification process), sensors from the wearable device 120, location data, and/or the like to determine that the user 140 is in possession of the wearable device 120.

In some embodiments, the user 140 may be able to decide what defines possession. For example, for operation request that are under “X” amount the user 140 may select to automatically allow the transaction when the wearable device 120 is determined to be with the user 140. Alternatively, the user 140 may select to require verification (e.g., agreement, fingerprint indication, particular number of taps, physical movement of the user, touch actions on a display, or the like) for operation requests that over “X” amount even when the wearable device 120 is determined to be with the use 140. Moreover, the user 140 may select the type and level of possession (e.g., multiple levels of authentication). For example, the user 140 may request that operational requests are approved when the wearable device 120 is found to be with the user 140. Alternatively, the user 140 may require that not only does the wearable device 120 need to be found to be with the user 140 or the user's mobile device 130, but must also identify a physiological reading of the user 140 that meets a stored physiological reading or receive a specific verification from the user 140. As such, even if the wearable device 120 and the mobile device 130 are compromised, the person that compromised the devices does not know how to provide the specific types of authentication of possession.

Upon determination that the user 140 is in possession of the wearable device 120, the process 200 advances to block 230 to authenticate the user's access to the at least one account, indicated in the operation request. In some embodiments, this authentication process is the same as an authentication process at a point-of-sale terminal, ATM, or the like. Therefore, if the user 140 purchases a product or service using one of the identified accounts (after the system has determined that the user is in possession of the wearable device 120), and verifies this account at a point-of-sale terminal, then the system has authenticated the account. As previously discussed, the authentication may be made after it is determined that the user 140 is in possession of the wearable device 120; however, in some embodiments the authentication may require further verification by the user 140.

In other embodiments, the system authenticates at least one account before any transactions are made. For example, the system may ask for a PIN number associated with a debit account, a signature associated with a credit account, a fingerprint associated with an account, a facial scan associated with an account, a voice command associated with an account, and the like. The system may receive a user's authorization input through a user interface (including sensors, buttons, touchscreens, or the like) of a mobile device 130 associated with the user, through a user interface (including sensors, buttons, touchscreens, or the like) of the wearable device (especially when the wearable device includes payment account functionality), a website, an ATM user interface, a point-of-sale terminal user interface, or the like. In some embodiments, the account authorization is part of a payment process for the user 140, and therefore the authorization of the account may be used to authorize the account for the current payment.

Once it is determined that the user 140 is in possession of the wearable device 120 and is authorized to access the one or more accounts, the process 200 advances to block 240 to grant the operation request to control the at least one account indicated in the operation request, thereby enabling the user 140 to use the wearable device 120 as a remote control for financial account operation. An entity controlling the financial account of the user 140, and running this process 200, is willing to allow the wearable device 120 to act as a controller for an account because the association of a wearable device with its owner gives the entity a reasonably certainty that the account owner is the one accessing and taking actions on the account. As such, the entity may continuously monitor the wearable device 120 to determine whether it remains in the possession of the user 140. This monitoring may include receiving indications from sensors on the wearable device that the device is in contact with the user 140, that the wearable device 140 is in a locked or latched state (or is otherwise connected with the user for use), and the like. If the system determines that the wearable device 120 has been removed from the user 140, then the system may end the user's operation request to control the at least one account. Such a step may be accompanied by a prompt to the user to gain possession of the wearable device 120 and/or provide an authentication measure to regain control of the account through the wearable device.

After the system grants operation of the at least one account to the user 140 via the wearable device, the process 200 moves to block 250 to provide a notification to the user 140 indicating that the operation request has been granted. This indication may be communicated via the wearable device 120, a webpage, a mobile device 130 associated with the user 140, or the like. The notification may comprise a light indicator, an audible indicator, a visual indicator, a vibration indication, a text message, an email, a webpage pop-up, or any other means of notification capable of letting the user 140 know that the user 140 has been granted the ability to control the account through the wearable device.

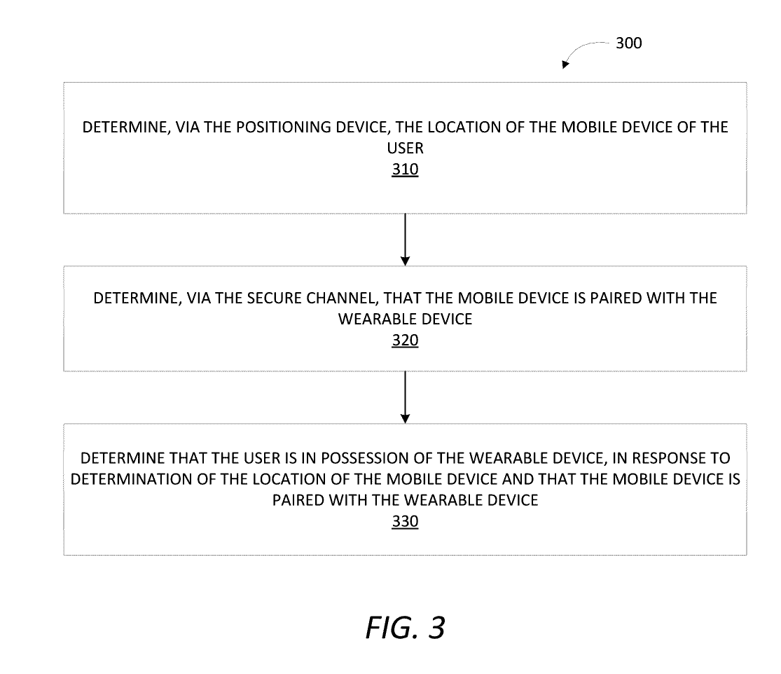

FIG. 3 illustrates a general process flow 300 for determining whether or not the user 140 is in possession of a wearable device 120 in conjunction with a mobile device 130, in accordance with one embodiment of invention. At block 310, the process 300 determines the location of the mobile device 130 via a positioning device 135 therein, which may include a NFC interface having one or more proximity sensors embedded, such as a RFID tag. In some embodiments, the location of the mobile device 130 is determined by a proximity system installed on the system, which is configured to use proximity sensors located at various locations throughout the world to detect the presence of the one or more proximity sensors associated with the positioning device 135 of the mobile device 130. In some embodiments, triangulation of cellular signals transmitted (e.g., via a GPS transceiver, Wi-Fi triangulation, Bluetooth device, or other signals) from the mobile device 130 may be used to identify the location of the mobile device 130

At block 320, the process 300 determines whether or not the mobile device 130 is paired with the wearable device 120, via a secure channel between the wearable and mobile devices 120, 130 over a short range wireless communication channel (e.g., within a particular distance). The secure channel is established utilizing the system application directives, or one or more wearable applications downloaded onto the mobile device 130 and/or the wearable device 120. The system may determine that the wearable device 120 and the mobile device 130 are paired due to their locations being within a certain geographic distance, either through sensors on the devices or through the system's determined location of both devices (e.g., NFC, RFID, GPS, Bluetooth, or the like).

At block 330, the process 300 determines that the user is in possession of the wearable device 120, in response to the operations described in block 310 and block 320. In some embodiments, the system makes this determination in the same or a similar manner to the determination in block 220 of FIG. 2. In other embodiments, the determination that the wearable device 120 and the mobile device 130 of the user 140 are within close proximity to each other is enough to allow the system to presume that the user 140 is in control of the wearable device 120. If the system knows that the mobile device 130 is associated with the at least one accounts referred to in FIG. 2, then the system can use the fact that the user 140 is in possession of the wearable device 120 as a presumption that the wearable device 120 may be safely used as a controller for the at least one account. Therefore the system may authorize the account, grant the operation request to control the at least one account, and notify the user of the grant, as previously discussed with respect to blocks 230, 240, and 250 in FIG. 2.

Although a number of implementations have been described in detail above, other modifications, variations and implementations are possible in light of the foregoing teaching. The terminology used herein is for the purpose of describing particular embodiments only and is not intended to be limiting of embodiments of the disclosure. As used herein, the singular forms “a,” “an,” and “the” are intended to include the plural forms as well, unless the context clearly indicates otherwise. As used herein, all numbers may be read as if prefaced by the term “about,” even if the term does not expressly appear. Also, any numerical range recited herein is intended to include all sub-ranges subsumed therein. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to embodiments of the disclosure in the form disclosed. Many modifications and variations will be apparent to those of ordinary skill in the art without departing from the scope and spirit of embodiments of the disclosure. The embodiment was chosen and described in order to best explain the principles of embodiments of the disclosure and the practical application, and to enable others of ordinary skill in the art to understand embodiments of the disclosure for various embodiments with various modifications as are suited to the particular use contemplated. Although specific embodiments have been illustrated and described herein, those of ordinary skill in the art appreciate that any arrangement which is calculated to achieve the same purpose may be substituted for the specific embodiments shown and that embodiments of the disclosure have other applications in other environments. This application is intended to cover any adaptations or variations of the present disclosure. Thus, although not expressly described, any or each of the features of the invention disclosed herein may be combined in any manner.

Accordingly, the invention is to be defined not by the preceding illustrative description but instead by the scope of the following claims.

To supplement the present disclosure, this application further incorporates entirely by reference the following commonly assigned patent applications:

| | U.S. patent application | | |
|---|---|---|---|
| Docket Number | Ser. No. | Title | Filed On |
| 6804US1.014033.2499 | | AUTHENTICATION | Concurrently |
| | | SYSTEM USING | Herewith |
| | | WEARABLE | |
| | | PRESENCE TO | |
| | | MAINTAIN | |
| | | ACCOUNT | |
| | | AUTHENTICATION | |
| 6806US1.014033.2501 | | A SYSTEM FOR | Concurrently |
| | | AUTHENTICATING A | Herewith |
| | | WEARABLE DEVICE | |
| | | FOR TRANSACTION | |
| | | QUEUING | |
| 6809US1.014033.2506 | | A SYSTEM FOR | Concurrently |
| | | AUTHENTICATING | Herewith |
| | | THE USE OF A | |
| | | WEARABLE DEVICE | |
| | | TO EXECUTE A | |
| | | TRANSACTION | |
| 6834US1.014033.2507 | | A SYSTEM FOR | Concurrently |
| | | AUTHENTICATING A | Herewith |
| | | MOBILE DEVICE FOR | |
| | | COMPREHENSIVE | |
| | | ACCESS TO A | |
| | | FACILITY | |

What is claimed is:

1. A system for using wearable presence to control user account operation, the system comprising:
a computer apparatus comprising at least one processor and a memory; and
a software module, stored in the memory, comprising computer readable code executable by the processor to cause the processor to:
receive, via a communication interface, an operation request from a wearable device of a user to control the operation of at least one account of the user using the wearable device, wherein the wearable device comprises one or more sensors configured to gather user data comprising physiological data, movement data, or a combination of both, wherein the operation comprises turning on or off the at least one account or placing a limit on a payment for a transaction;
determine that the user is in possession of the wearable device, based on the user data;
grant the operation request to control the at least one account, based at least partially on the determination that the user is in possession of the wearable device; and
provide, via the communication interface, a notification to the user indicating that the operation request has been granted.

2. The system of claim 1, wherein the wearable device is paired with a mobile device of the user via a secure channel between the two devices over a short range wireless communication channel, wherein the secure channel is established by utilizing one or more applications provided by the system or by third-parties, and wherein the mobile device comprises a positioning device.

3. The system of claim 2, wherein the user data is transmitted to the mobile device or to an online storage site, both accessible to the system.

4. The system of claim 2, wherein the operation request is sent from the mobile device.

5. The system of claim 2, wherein the software module is further configured to:
determine, via the positioning device, the location of the mobile device of the user;
determine, via the secure channel, that the mobile device is paired with the wearable device; and
determine that the user is in possession of the wearable device, in response to the determination of the location of the mobile device and that the mobile device is paired with the wearable device.

6. The system of claim 1, wherein the operation request comprises the user account information comprising a username, a password, a personal identification number (PIN), an account number, a card number, one or more related accounts, or any combination thereof.

7. The system of claim 1, wherein the operation further comprises preauthorizing one or more transactions, approving one or more transactions that are forwarded to the wearable device for approval, periodically transferring a pre-specified amount from one account to another account, or any combination thereof.

8. The system of claim 1, wherein the physiological data comprises heart rate, blood pressure, fingerprints, finger, wrist, or palm vein or skin patterns, temperature, skin reading, fluid reading, or breath reading; wherein the movement data comprises body movements or gait.

9. The system of claim 1, wherein the wearable device comprises a watch, a wristband, an ear-pod, a necklace, a wristlet, an anklet, an earring, a headband, a ring, a belt, eyeglasses, contact lenses, or clothing.

10. The system of claim 1, wherein the at least one account comprises a deposit account, a debt account, a savings account, a checking account, an investment account, a money market account, or a credit account.

11. A computer-implemented method for using wearable presence to control user account operation, the method comprising:
receiving, via a communication interface, an operation request from a wearable device of a user to control the operation of at least one account of the user using the wearable device, wherein the wearable device comprises one or more sensors configured to gather user data comprising physiological data, movement data, or a combination of both, wherein the operation comprises turning on or off the at least one account, or placing a limit on a payment for a transaction;
determining that the user is in possession of the wearable device, based on the user data;
granting the operation request to control the at least one account, based at least partially on the determination that the user is in possession of the wearable device; and
providing, via the communication interface, a notification to the user indicating that the operation request has been granted.

12. The computer implemented method of claim 11, wherein the wearable device is paired with a mobile device of the user via a secure channel between the two devices over a short range wireless communication channel, wherein the secure channel is established by utilizing one or more applications provided by the system or by third-parties, and wherein the mobile device comprises a positioning device.

13. The computer implemented method of claim 12, wherein determining further comprises:
determining, via the positioning device, the location of the mobile device of the user;
determining, via the secure channel, that the mobile device is paired with the wearable device; and
determining that the user is in possession of the wearable device, in response to the determination of the location of the mobile device and that the mobile device is paired with the wearable device.

14. The computer implemented method of claim 11, wherein the operation request comprises the user account information comprising a username, a password, a personal identification number (PIN), an account number, a card number, one or more related accounts, or any combination thereof.

15. The computer implemented method of claim 11, wherein the operation further comprises preauthorizing one or more transactions, approving one or more transactions that are forwarded to the wearable device for approval, periodically transferring a pre-specified amount from one account to another account, or any combination thereof.

16. The computer implemented method of claim 11, wherein the wearable device comprises a watch, a wristband, an ear-pod, a necklace, a wristlet, an anklet, an earring, a headband, a ring, a belt, eyeglasses, contact lenses, or clothing.

17. The computer implemented method of claim 11, wherein the at least one account comprises a deposit account, a debt account, a savings account, a checking account, an investment account, a money market account, or a credit account.

18. A computer program product for using wearable presence to control user account operation, the computer program product comprising a non-transitory computer readable medium having one or more computer-readable programs stored therein, and the computer readable programs, when executed by a computer apparatus, cause the computer apparatus to perform the following steps:
receiving, via a communication interface, an operation request from a wearable device of a user to control the operation of at least one account of the user using the wearable device, wherein the wearable device comprises one or more sensors configured to gather user data comprising physiological data, movement data, or a combination of both, wherein the operation comprises turning on or off the at least one account or placing a limit on a payment for a transaction;
determining that the user is in possession of the wearable device, based on the user data;
granting the operation request to control the at least one account, based at least partially on the determination that the user is in possession of the wearable device; and
providing, via the communication interface, a notification to the user indicating that the operation request has been granted.

19. The computer program product of claim 18, wherein the wearable device is paired with a mobile device of the user via a secure channel between the two devices over a short range wireless communication channel, wherein the secure channel is established by utilizing one or more applications provided by the system or by third-parties, and wherein the mobile device comprises a positioning device.

20. The computer program product of claim 19, wherein determining further comprises:
determining, via the positioning device, the location of the mobile device of the user;
determining, via the secure channel, that the mobile device is paired with the wearable device; and
determining that the user is in possession of the wearable device, in response to the determination of the location of the mobile device and that the mobile device is paired with the wearable device.
